(19) United States
(12) Patent Application Publication
(10) Pub. No.: US 2023/0161725 A1
(43) Pub. Date: May 25, 2023

(54) SMART SCALABLE DESIGN FOR A CROSSBAR

(71) Applicant: Meta Platforms, Inc., Menlo Park, CA (US)

(72) Inventor: Linda Cheng, San Jose, CA (US)

(21) Appl. No.: 17/534,109

(22) Filed: Nov. 23, 2021

(51) Int. Cl. G06F 13/40; G06F 9/38; G06F 9/30

(52) U.S. Cl. CPC G06F 13/4022; G06F 9/3867; G06F 9/30047; G06F 13/4027

(57) ABSTRACT

A system is described. The system includes a first group of data ports of one or more first elements of an integrated circuit and a second group of data ports of one or more second elements of the integrated circuit. The system also includes a point-to-point connection between a first data port of the first group of data ports to a second data port of the second group of data ports. In addition, the system includes, for the first data port, a distinct crossbar connected to every data port of the second group of data ports.

### BACKGROUND

Crossbars are used to connect each of a first set of ports with each of a second set of ports. The ports are generally connected via a full mesh within the crossbar. For example, the crossbar may include source ports and destination ports. Each source port is connected via the mesh with each destination port. Although this allows full connectivity between the ports, the number of wires within the mesh increases exponentially with the number of ports. As a result, larger numbers of wires are required to be routed within an amount of space that is desired to remain small. Consequently, scaling the crossbar may be challenging. Accordingly, what is needed is a mechanism for transferring data between large numbers of ports.

### BRIEF DESCRIPTION OF THE DRAWINGS

Various embodiments are disclosed in the following detailed description and the accompanying drawings.

FIGS. 1A-1C are diagrams depicting an embodiment of a system for routing data.

FIG. 2 is a diagram depicting an embodiment of a system for routing data.

FIGS. 3A-3B are diagrams depicting an embodiment of a system for routing data using pipelines.

FIG. 4 is a diagram depicting an embodiment of a system for routing data using control signals.

FIG. 5 is a flow-chart depicting a method for routing data.

FIG. 6 is a flow-chart depicting a method for providing a routing system.

### DETAILED DESCRIPTION

The disclosure can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the disclosure may take, may be referred to as techniques. In general, the order of the steps of disclosed processes may be altered within the scope of the disclosure. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments is provided below along with accompanying figures that illustrate the principles of the disclosure. The disclosure is described in connection with such embodiments, but the disclosure is not limited to any embodiment. The scope of the disclosure is limited only by the claims and the disclosure encompasses numerous alternatives, modifications and equivalents. Numerous specific details are set forth in the following description in order to provide a thorough understanding of the disclosure. These details are provided for the purpose of example and the disclosure may be practiced according to the claims without some or all of these specific details. For the purpose of clarity, technical material that is known in the technical fields related to the disclosure has not been described in detail so that the disclosure is not unnecessarily obscured.

Various applications require each of a first set of circuit elements to be connected to each of a second set of circuit elements. For example, each processing engine in a set of processing engines may be desired to be connected to each cache in a set of caches. Crossbars are one mechanism for accomplishing this connection. A crossbar generally includes multiple data ports and a full mesh interconnecting the data ports. Data ports of a given type have connectivity to any of the data ports of another type through the full mesh. The data ports may be connected to the other elements in an integrated circuit between which data is desired to be transferred. A crossbar is also generally laid out such that its data ports align with the ports of the elements the crossbar interfaces with. For example, a crossbar may be used to connect a set of processing engines with a set of memories, such as caches. The data ports on a first side of the crossbar are connected with the processing engines’ ports, while the data ports on the opposite side of the crossbar are connected with the corresponding caches’ ports. The full mesh within the crossbar connects each data port for a processing engine with all data ports for the caches, and vice versa.

Although the crossbar allows for connectivity between elements of an integrated circuit, there are drawbacks. The number of wires in the full mesh increases exponentially with the number of data ports. Further, each data port may carry hundreds of signals. Thus, the number of wires increases rapidly with the number of data ports. For example, suppose there are three types of data ports (A, B, C) which are desired to be connected (each data port of each type connected to each data port of another type). The number of wires routed in the full mesh for the crossbar is (bus width)* [number of A data ports *(number of B data ports + the number of C data ports) + number of B data ports*(number of C data ports + number of A data ports) + number of C data ports*(number of A data ports + number of B data ports)]. If the number of A data ports is 8, the number of B data ports is 8, the number of C data ports is 2, and the bus width is 500 wires, the number of wires routed is 96,000. Thus, the number or wires required to be routed in the full mesh increases exponentially with the number of data ports. If data ports of the same type are desired to be connected (e.g. every data port A connected to every other data port A), the situation is further complicated. As a result, providing the crossbar for a larger number of data ports is challenging, particularly if the space allocated for the crossbar is small. Accordingly, what is needed is a mechanism for scaling the crossbar to larger numbers of data ports.

A system that routes data is described. The system includes a first group of data ports of one or more first elements of an integrated circuit and a second group of data ports of one or more second elements of the integrated circuit. The system also includes a point-to-point connection between a first data port of the first group of data ports to a second data port of the second group of data ports. In addition, the system includes, for the first data port, a distinct crossbar connected to every data port of the second group of data ports. In some embodiments, the distinct crossbar for the first data port includes a pipeline having multiple pipeline states that connect to each data port of the second group of data ports.

A method includes providing data from a first data port to a second data port. The first data port is one of a first group of data ports for one or more first elements of an integrated circuit. The second data port is one of a second group of data ports of one or more second elements of the integrated circuit. The data is provided via a distinct crossbar connected from the first data port to every data port of the second group of data ports. The method also includes providing a valid signal from the first data port to the second data port. The valid signal is provided via a point-to-point connection between the first data port and the second data port. The point-to-point connection is one of a plurality of point-to-point connections between each of the first group of data ports and each of the second group of data ports. The valid signal and the data are coincident at the second data port.

A method for providing a system that routes data is described. The method includes providing a first group of data ports of one or more first elements of an integrated circuit. The method also includes providing a second group of data ports of one or more second elements of the integrated circuit. A point-to-point connection is provided. The point-to-point connection is between a first data port of the first group of data ports and a second data port of the second group of data ports. For the first data port, a distinct crossbar is provided. The distinct crossbar is connected to every data port of the second group of data ports.

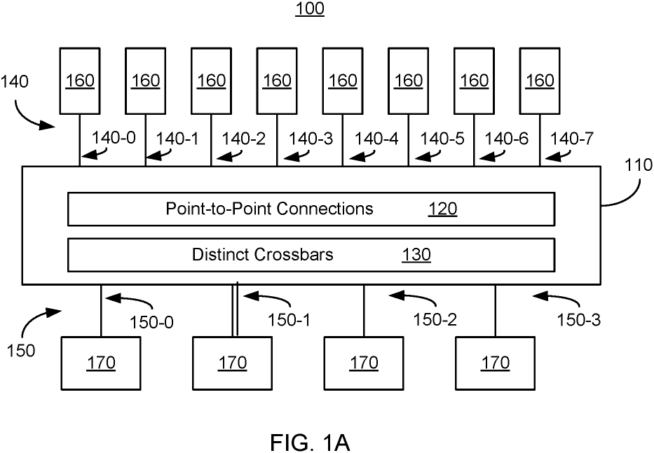

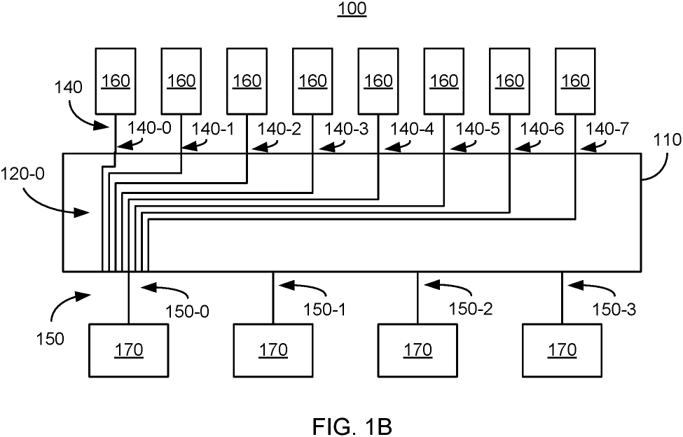

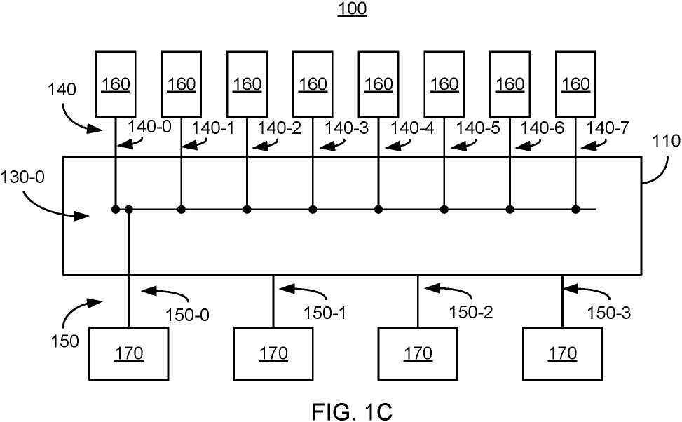

FIGS. 1A-1C are diagrams depicting an embodiment of computer system 100 including system 110 for routing data. FIG. 1A is a bock diagram, while FIGS. 1B and 1C depict aspect of system 100. For clarity, only a portion of system 100 is depicted. System 100 may be or include an integrated circuited and/or its components. System 100 includes routing system 110 and elements 160 and 170. For example, elements 160 may include processing engines, while elements 170 may include memories such as caches, or vice versa. Elements 160 and 170 are depicted as being directly coupled to routing system 110. In some embodiments, other component(s) may be coupled between elements 160 and/or 170 and routing system 110. Particular numbers of elements 160 and 170 are shown. However, in other embodiments, another number of elements 160 and/or 170 may be present. Further, although two sets of elements 160 and 170 are shown, in other embodiments, additional elements may be present. Such elements may have corresponding data ports in routing system 110.

Routing system 110 has data ports 140-0, 140-1, 140-2, 140-3, 140-4, 140-5, 140-6, and 140-7 (collectively or generically data port(s) 140) and data ports 150-0, 150-1, 150-2, and 150-3 (collectively or generically data port(s) 150) corresponding to elements 160 and 170, respectively. Although depicted as a single line, data ports 150 and 160 generally each include multiple wires. Routing system 110 allows for transfer of data from each data port 140, and thus each element 160, to all data ports 150, and thus all elements 170. Similarly, routing system 110 allows for transfer of data from each data port 150, and thus element 170, to all data ports 140, and thus all elements 160. Routing system 110 may be viewed as functioning as a crossbar. Thus, routing system 110 may be termed a crossbar. However, instead of the mesh connections of a crossbar, routing system 110 includes point-to-point connections 120 and distinct crossbars 130.

Point-to-point connections 120 provide a point-to-point connection from each data port 150 to every data port 140. Similarly, point-to-point connections 120 provide a point-to-point connection from each data port 140 to every data port 150. For example, FIG. 1B depicts point-to-point connections 120-0 for data port 150-0. Thus, a connection between data port 150-0 is provided to every data port 140-0, 140-1, 140-2, 140-3, 140-4, 140-5, 140-6, and 140-7 (collectively or generically data ports 140). Similar point-to-point connections may be present for data ports 150-1, 150-2, and 150-3. In some embodiments, analogous point-to-point connections are provided between data ports 150 and/or between data ports 140. Thus, in some embodiments, data ports of the same type may communicate. In other embodiments, data ports of the same type may not directly communicate. In other embodiments, point-to-point connections 120 may be provided in another manner, such as via a mesh connection. Point-to-point connections 120 may be used to provide valid signals, credit signals, and/or other configuration or control signals.

Routing system 110 also includes distinct crossbars 130. Distinct crossbars 130 allow for data transfer between data ports 140 and 150, and thus between elements 160 and 170. Although termed “crossbars”, distinct crossbars 130 need not be implemented as a crossbar. Instead, distinct crossbars 130 have a bus structure. In some embodiments, distinct crossbars 130 utilize individual pipelines between each (source) data port 150 and every (destination) data port 140, and vice versa. For example, FIG. 1C depicts an embodiment of distinct crossbar 130-0 for data port 150-0. Data ports 150-1, 150-2, and 150-3 include analogous distinct crossbars. Similarly, data ports 140 may include analogous distinct crossbars. In some embodiments, analogous distinct crossbars are provided between data ports 150 and/or between data ports 140. Thus, in some embodiments, data ports of the same type may exchange data. In other embodiments, data ports of the same type may not directly exchange data.

Routing system 110 allows for the exchange of data between elements 160 and 170 via point-to-point connections 120 and distinct crossbars 130. For example, to transfer data from element 170 (e.g. a cache) via data port 150-0, routing system 110 provides a valid signal on point-to-point connections 120-0 for each data port 140 that will receive data. Further, data from element 170 is transferred from port 150-0 over distinct crossbar 130-0. Valid signals provided via point-to-point connections 120-0 may be timed such that elements 160 are notified to pull data from the corresponding port 140-0, 140-1, 140-2, 140-3, 140-4, 150-5, 140-6 or 140-7 at the appropriate time. In some embodiments, the valid signal provided via point-to-point connections 120-0 to a particular port 140 is coincident with provided via distinct crossbar 130-0 at that particular port 140. For example, suppose data from port 150-0 is transferred to data port 140-3 and to data port 140-4. This data is present at data ports 140-3 and 140-4 at times t1 and t2, which may correspond to clock cycle 3 and clock cycle 4 from data being sent from data port 150-0. In some embodiments, valid signals from data port 150-0 provided via point-to-point connections 120-0 are also present at data ports 140-3 and 140-4 at times t3 and t4, respectively. Data may then be pulled, or otherwise received, from data ports 140-3 and 140-4. In some embodiments, a credit system is also used by source data ports 140 and/or 150 to determine whether data may be sent to a particular destination data port 150 and/or 140, respectively. In such embodiments, the destination port provides a credit release signal, indicating that data may be received on the corresponding data port. In the example above, destination data ports 140-3 and 140-4 each provide a credit release signal to data port 150-0 in response to data being pulled from data ports 140-3 and 140-4, respectively, by the corresponding elements 160. In some embodiments, the credit is based on a round trip time added to an overhead for the source data port and the destination data port. Thus, the credits corresponding to data port 140-3 may differ from the credits corresponding to data port 140-4 for port 150-0. Thus, routing system 110 may route data between elements 160 and 170. Further, routing system 110 may be extended to more than two types of data ports.

Using routing system 110, system 100 may be capable of routing data between the desired elements 160 and 170, such as processing engines and caches. Moreover, system 100 may be more readily scaled to larger numbers of elements 160 and/or 170. Routing system 110 uses point-to-point connections 120 in combination with distinct crossbars 130 having a bus structure (e.g. pipelines). Because routing system 110 uses distinct crossbars 130 in combination with point-to-point connections 120, routing system 110 includes one distinct crossbar 130 per data port 140 and 150. Thus, the number of wires utilized for routing system 110 increases linearly with the number of data ports. Stated differently, the number of wires routed is (bus width)* [total number of tracks] = (bus width)*[∑(number of data ports)]. For example, suppose there are three types of data ports (A, B, C) which are desired to be connected in a manner analogous to routing system 110. This is analogous to the example described above with respect to a full mesh. The number of wires routed in the direct crossbar 130 routing system 110 is (bus width)* [number of A data ports + number of B data ports + the number of C data ports)]. If the number of A data ports is 8, the number of B data ports is 8, the number of C data ports is 2, and the bus width is 500 wires, the number of wires routed is 9,000. The inclusion of the point-to-point connections between data ports does not markedly change the number of wires required. Thus, routing system 110 scales much more readily with the number of ports. Further, routing system 110 may occupy a smaller amount of space as routing system 110 is scaled to larger numbers of data ports. Consequently, routing system may 110 may significantly improve fabrication, scalability, and performance, particularly for systems 100 using large number(s) of elements 160 and/or 170.

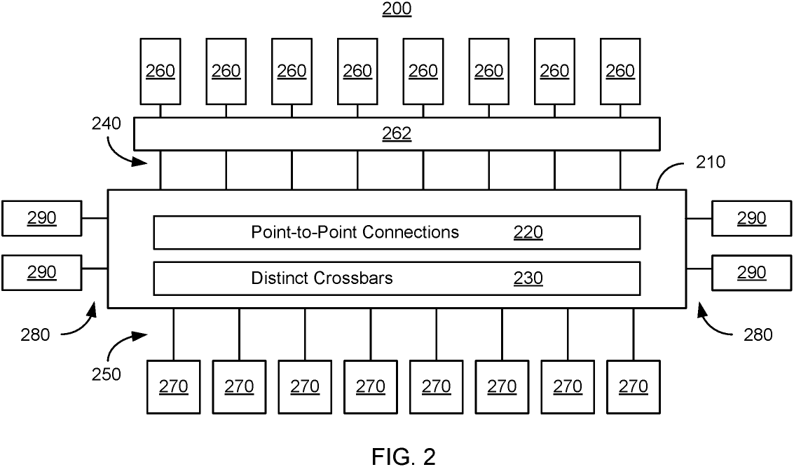

FIG. 2 is a diagram depicting an embodiment of system 200 for routing data. For clarity, only a portion of system 200 is depicted. System 200 may be or include an integrated circuited and/or its components. System 200 is analogous to system 100. Consequently, analogous components have similar labels. System 200 includes routing system 210 and elements 260 and 270 that are analogous to routing system 110 and elements 160 and 170, respectively. In addition, a larger number of elements 270 are present than in system 100. Elements 260 and 270 may include processing engines, memories such as caches, and/or other components. Although elements 270 are depicted as being directly coupled to routing system 210, in some embodiments, other component(s) may be coupled between elements 270 and routing system 210. In the embodiment shown, component 262 is coupled between elements 260 and routing system 210. For example, component 262 may perform hashing and/or other functions for elements 260. In some embodiments, component 262 may be omitted. Although particular numbers of elements 260 and 270 are shown, in other embodiments, another number of elements 260 and/or 270 may be present.

Routing system 210 also includes ports 280 corresponding to elements 290 of system 200. For example, elements 290 may be other processors, such as systems on a chip (SOCs), memories, bridges, or other components of system 200 desired to be connected with elements 260 and/or 270 via routing system 210. Thus, connection to three types of elements, 260, 270 and 290 is provided via routing system 210. Point-to-point connections 220 and distinct crossbars 230 also include structures for ports 280. For example, point-to-point connections 220 include additional connections to ports 280. Each distinct crossbar 230 provided for ports 240 and 250 may include additional pipeline stages for data transfer to ports 280. Further, distinct crossbars 230 include additional distinct crossbars for ports 280. Thus, routing system 110 may be expanded to additional ports and/or additional types of elements for which connection is desired.

System 200 shares the benefits of system 100. Routing system 210 is capable of routing data between the desired elements 260, 270, and 290. Because routing system 210 uses distinct crossbars 230 in combination with point-to-point connections 220, routing system 210 includes one distinct crossbar 230 per data port 240, 250, and/or 280. The complexity of routing system 210 increases linearly with the number of data ports. Thus, routing system 210 scales much more readily with the number of data ports. Moreover, routing system 210 may occupy less space. Consequently, routing system may 210 may significantly improve fabrication and performance, particularly for systems 200 using large number(s) of elements 260, 270 and/or 290.

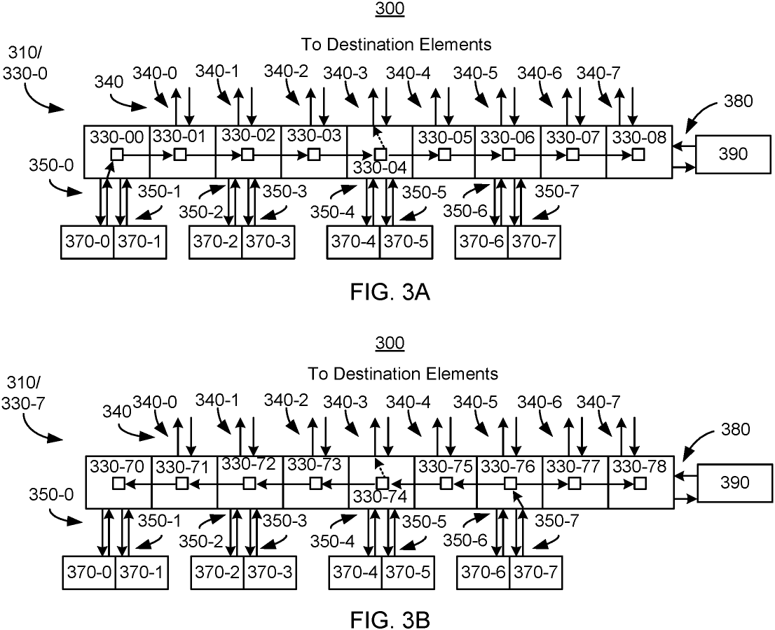

FIGS. 3A-3B are diagrams depicting an embodiment of system 300 that routes data via pipelines. System 300 may be or include an integrated circuited and/or its components. System 300 is analogous to system(s) 100 and/or 200. Consequently, analogous components have similar labels. System 300 includes routing system 310 analogous to routing system(s) 110/210, elements 370-0, 370-1, 370-2, 370-3, 370-4, 370-5, 370-6, and 370-7 (collectively or generically elements 370) that are analogous to elements 170/270, and element 390 that is analogous to element 290. Although not shown, elements that are analogous elements 160 and/or 260 may be coupled to routing system 310. Elements 370 may include memories such as caches, processing engines, and/or other components. Although elements 370 are depicted as being directly coupled to routing system 310, in some embodiments other component(s) may be coupled between elements 370 and routing system 310. Some embodiments, a component may be coupled between elements (not shown) and routing system 310. In system 300, elements 370 are source elements from which data is being transferred to destination elements.

Routing system 310 includes distinct crossbars 330 and point-to-point connections (not shown for clarity). Also shown are source data ports 350-0, 350-1, 350-2, 350-3, 350-4, 350-5, 350-6, and 350-7 (collectively or generically port(s) 350), destination data ports 340-0, 340-1, 340-2, 340-3, 340-4, 340-5, 340-6, and 340-7 (collectively or generically port(s) 340), and data port 380. The arrows for ports 340, 350, and 380 indicate that information may flow in either direction for a particular port 340, 350, and 380. FIG. 3A depicts distinct crossbar 330-0 corresponding to data port 350-0. FIG. 3B depicts distinct crossbar 330-7 corresponding to data port 350-7.

Referring to FIG. 3A, crossbar 330-0 is a pipeline including pipeline stages 330-00, 330-01, 330-02, 330-03, 330-04, 330-05, 330-06, 330-07, and 330-08 (collectively or generically 330-0i). In another embodiment, pipeline 330-0 may have a different number of stages 330-0i. In some embodiments, each stage 330-0i occupies approximately one square mil and may include at least one set of registers. In some embodiments, data travels down pipeline 330-0 by one stage 330-0i per clock cycle. In the embodiment shown in FIG. 3A, data is travels in a single direction from port 350-0 through pipeline 330-0 toward port 380. The direction of travel of data is shown by arrows within pipeline stages 330-0i. In the embodiment shown, a packet of data from port 350-0 enters at pipeline stage 330-00 and travels down pipeline 330-0 in one stage 330-0i per clock cycle. FIG. 3A depicts a situation in which data is provided to port 340-3. A corresponding valid signal is provided by port 350-0 to port 340-3 via a point-to-point connection (not shown in FIGS. 3A-3B). In some embodiments, the valid signal is a valid bit that is “1” when data is to be provided (e.g. pulled) from a destination port 340 and “0” otherwise. The valid signal “1” is at port 340-3 substantially coincident with the data residing in pipeline stage 330-04. Thus, on the fourth clock cycle, data from port 350-0 is at pipeline stage 330-04 and the valid signal “1” is at port 340-4. Consequently, data may be pulled from pipeline stage 330-04 to the desired port 340-4 and element (not shown in FIG. 3A).

Referring to FIG. 3B, crossbar 330-7 is a pipeline including pipeline stages 330-70, 330-71, 330-72, 330-73, 330-74, 330-75, 330-76, 330-77, and 330-78 (collectively or generically 330-7i). In another embodiment, pipeline 330-7 may have a different number of stages 330-7i. In some embodiments, each stage 330-7i occupies approximately one square mil and may include one set of registers. In some embodiments, data travels down pipeline 330-7 by one stage 330-7i per clock cycle. The direction of travel of data is shown by arrows within pipeline stages 330-7i. In the embodiment shown in FIG. 3B, data in pipeline 330-7 travels in multiple directions. Some data travels from port 350-7 through pipeline 330-7 toward port 380. However, some data travels from port 350-7 through pipeline 330-7 toward port 340-0. This is because of the location of port 350-7 with respect to pipeline stages 340-7i. In the embodiment shown, a packet of data from port 350-7 enters at pipeline stage 330-76 and travels through pipeline 330-7 in one stage 330-7i per clock cycle. Thus, after the first clock cycle, data could be at pipeline stage 330-77 or 330-76. FIG. 3B depicts a situation in which data is provided to port 340-3. Thus, data travels to pipeline stage 330-74 in two clock cycles. A corresponding valid signal is provided by port 350-7 to port 340-3 via a point-to-point connection (not shown in FIGS. 3A-3B). As discussed with respect to FIG. 3A, the valid signal may be a valid bit that is “1” when data is to be provided (e.g. pulled) from a destination port 340 and “0” otherwise. The valid signal “1” is at port 340-3 substantially coincident with the data residing in pipeline stage 330-74. Thus, on the second clock cycle, data from port 350-7 is at pipeline stage 330-74 and the valid signal “1” is at port 340-4. Consequently, data may be pulled from pipeline stage 330-74 to the desired port 340-4 and element (not shown in FIG. 3B).

System 300 shares the benefits of system(s) 100 and/or 200. Routing system 310 is capable of routing data between the desired elements using distinct pipelines, such as data pipelines 330-0 and 330-7, as distinct crossbars. Routing system 310 uses pipelines 330-0 and 330-7 (i.e. distinct crossbars) in combination with point-to-point connections (not shown in FIGS. 3A-3B). Routing system 310 includes one pipeline 330 (i.e. distinct crossbar) per source data port 350, 340, and/or 380. The complexity of routing system 310 increases linearly with the number of data ports. Thus, routing system 310 scales much more readily with the number of data ports. Moreover, routing system 310 may occupy less space. Consequently, routing system may 310 may significantly improve fabrication and performance, particularly for systems 300 using large number(s) of elements such as elements 370 and/or 390.

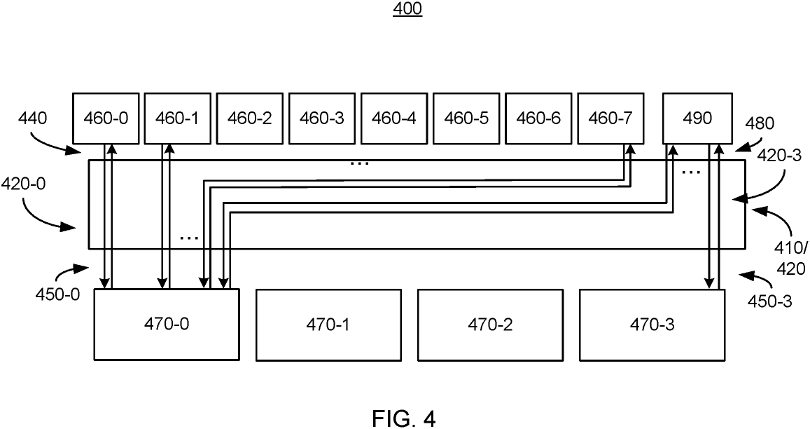

FIG. 4 is a diagram depicting an embodiment of system 400 that routes data utilizing point-to-point valid signals and credit signals. System 400 may be or include an integrated circuited and/or its components. System 400 is analogous to system(s) 100, 200 and/or 300. Consequently, analogous components have similar labels. System 400 includes routing system 410 analogous to routing system(s) 100/200/300, elements 470-0, 470-1, 470-2 and 470-3, (collectively or generically elements 470) that are analogous to elements 170/270/370. Also shown are elements that are elements 460-0, 460-1, 460-2, 460-3, 460-4, 460-5, 460-6, and 460-7 analogous to elements 160 and/or 260, and element 490 analogous to elements 290 and/or 390. Elements 460, 470, and 490 may include processing engines, memories such as caches, and/or other components. Although elements 460, 470, and 490 are depicted as being directly coupled to routing system 410, in some embodiments other component(s) may be coupled between the elements and routing system 410. In system 400, elements 470 are source elements from which data is being transferred to destination elements.

Routing system 410 includes distinct crossbars such as pipelines (not shown in FIG. 4) and point-to-point connections 420. For simplicity only point-to-point connections 420-0 for data port 450-0 and a portion of connections 420-3 are shown for data port 450-3 are shown. The arrows for data ports 440, 450, and 480 indicate that information may flow in either direction for a particular data port 440, 450 and 480. Point-to-point connections 420-0 allow for valid bits to be sent from data port 450-0 and credit release signals to be sent by data ports 440 and 480. The valid signal may be provided from source data port 450-0 via point-to-point connections 420-0 to each of data ports 440 and 480 receiving data. Similarly, credit release signals may be provided from each data port 440 and 480 via point-to-point connections 420-0 to data port 450-0. Consequently, data may be pulled from the pipeline stage (not shown in FIG. 4) to the desired data port 440 and/or 480 and element 460 and/or 490.

System 400 shares the benefits of system(s) 100, 200 and/or 300. Routing system 410 is capable of routing data between the desired elements using distinct pipelines, or distinct crossbars, and point-to-point connections 420. The complexity of routing system 410 increases linearly with the number of data ports. Thus, routing system 410 scales much more readily with the number of data ports. Moreover, routing system 410 may occupy less space. Consequently, routing system may 410 may significantly improve fabrication and performance.

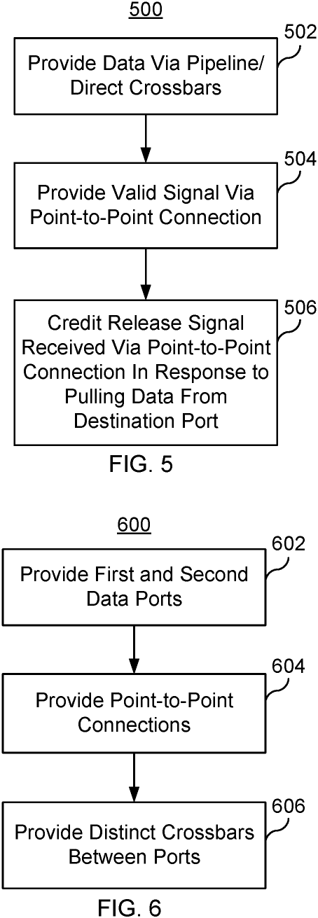

FIG. 5 is a flow-chart depicting method 500 for routing data. Method 500 may include additional steps, including substeps. Although shown in a particular order, steps may occur in a different order, including in parallel. Data is provided from each data port in a first group of data ports (source data ports) to each desired data port of a second data group of data ports (destination ports), at 502. The data is provided in 502 via distinct crossbars. Each distinct crossbar is from a data port of the source data ports to each of the destination data ports. In some embodiments, each distinct crossbar is a pipeline including multiple stages. Thus, 502 may include data being transferred from the source data ports through the pipeline stages to the appropriate destination data ports. As part of 502, each source data port may assign credits corresponding to the latency and overhead for each destination data port to which data is sent.

At 504, valid signal(s) are provided from the source data port(s) to each of the destination data ports that receive data. The valid signal(s) of 504 are provided via point-to-point connections between the source data ports and the destination data ports. In some embodiments, 502 and 504 are performed such that the valid signal and the data are coincident at particular destination data ports receiving data. As a result, destination data ports may be notified of the presence of data that should be pulled and provided to the corresponding elements. Data may be pulled from the appropriate pipeline stage(s). In response to the data being pulled, credit release signal(s) may be sent from the destination port(s) to the source data port(s) via point-to-point connections. Credit release signal(s) are received at the source port(s) from the destination port(s), at 506. Thus, the source port(s) may be notified of the destination ports’ ability to receive additional data.

For example, method 500 may be used in connection with system 300 of FIG. 3A. At 502, source data port 350-0 may send data for destination data port 340-3 via pipeline 330-0. Also at 502, credit corresponding to the four clock cycles used by the data to travel from pipeline stage 330-00 to 330-04 and any overhead is set. In addition, source port 350-0 may send a valid signal (e.g. set a valid bit to “1”) at 504. The valid signal is sent from source port 350-0 to destination port 340-3 via a point-to-point connection analogous to point-to-point connections 420-0 of FIG. 4. The valid signal and data are timed to be coincident at port 340-3 and pipeline stage 330-04, respectively. Thus, the data may be pulled from pipeline stage 330-04 at the appropriate time. At 506, destination data port 340-3 sends a credit release signal to source data port 350-0 via a point-to-point connection via a point-to-point connection analogous to point-to-point connections 420-0 of FIG. 4.

Using method 500, data may be routed between the desired elements using distinct pipelines and point-to-point connections. A routing system having a complexity that increases linearly with the number of data ports may be utilized. Thus, the benefits of such a routing system may be achieved.

FIG. 6 is a flow-chart depicting method 600 for providing a routing system. Method 600 may include additional steps, including substeps. Although shown in a particular order, steps may occur in a different order, including in parallel. At least first and second groups of data ports are provided, at 602. Data is desired to be transferred at least between data ports in the first group and data ports in the second group.

Point-to-point connections are provided between the each of the first group of data ports and every data port of the second group of data ports, at 604. In some embodiments, the direct connection may be capable of transmitting limited information, such as a valid bit and a credit release signal.

A distinct crossbar is provided for each of the data ports, at 606. The distinct crossbar provides data from each of the first group of data ports to every data port of the second group of data ports. For example, a pipeline from a data port of the first group of data ports including pipeline stages for each of the second group of data ports may be provided at 606. In some embodiments, 606 may be repeated to provide distinct crossbars (e.g. pipelines) for each of the second group of data ports. This may allow for transfer of data from the second group of data ports to the first group of data ports.

For example, method 600 may be used in connection with system 300 of FIGS. 3A and 3B. Data ports 340, 350, and 380 are provided, at 602. At 604, direct connections, such direction connections 420-0 of FIG. 4 are provided for each data port 340, 350 and 380. At 606, pipelines, such as pipelines 330-0 and 330-7, are provided. Thus, data ports, the control signals used in data transfer and pipelines used in actually transferring data may be fabricated.

Using method 600, a system for routing data between the desired elements may be fabricated. The routing system uses distinct pipelines and point-to-point connections. A routing system having a complexity that increases linearly with the number of data ports may be provided. Thus, the benefits of such a routing system may be achieved.

Although the foregoing embodiments have been described in some detail for purposes of clarity of understanding, the disclosure is not limited to the details provided. There are many alternative ways of implementing the disclosure. The disclosed embodiments are illustrative and not restrictive.

What is claimed is:

1. A system, comprising:
a first group of data ports of one or more first elements of an integrated circuit;
a second group of data ports of one or more second elements of the integrated circuit;
a point-to-point connection between a first data port of the first group of data ports to a second data port of the second group of data ports; and
for the first data port, a distinct crossbar connected to every data port of the second group of data ports.

2. The system of claim 1, wherein the point-to-point connection is one of a plurality of point-to-point connections between each of the first group of data ports and each of the second group of data ports and wherein the distinct crossbar is one of a plurality of distinct crossbars connecting each of the first group of data ports to every data port of the second group of data ports.

3. The system of claim 2, wherein the point-to-point connections carry a valid signal from the first group of data ports to each of the second group of data ports, the valid signal from the first data port being coincident at the second data port with data from the first data port for the second data port carried in the distinct crossbar for the first data port.

4. The system of claim 2, wherein the point-to-point connections carry at least one credit release signal between the first group of data ports and the second group of data ports, the credit release signal for the first data port being provided from the second data port in response to data from the first data port being pulled from the second data port.

5. The system of claim 4, wherein the credit release signal corresponds to a credit, the credit being based on a round trip time added to an overhead for the first data port and the second data port.

6. The system of claim 1, further comprising:
for the second group of data ports, an additional distinct crossbar providing a connection from the second data port to every data port of the first group of data ports.

7. The system of claim 6, wherein the additional distinct crossbar for the second data port includes a plurality of pipeline stages to the first group of data ports.

8. The system of claim 2, wherein the distinct crossbar for the first data port includes a plurality of pipeline stages to the second group of data ports.

9. The system of claim 1, wherein the first elements include a plurality of processing engines.

10. The system of claim 1, wherein the second elements include a plurality of caches.

11. A method, comprising:
providing data from a first data port to a second data port, the first data port being one of a first group of data ports of one or more first elements of an integrated circuit, the second data port being one of a second group of data ports of one or more second elements of the integrated circuit, the data being provided via a distinct crossbar connected from the first data port to every data port of the second group of data ports; and
providing a valid signal from the first data port to the second data port, the valid signal being provided via a point-to-point connection between the first data port and the second data port, the point-to-point connection being one of a plurality of point-to-point connections between each of the first group of data ports and each of the second group of data ports, the valid signal and the data being coincident at the second data port.

12. A method, comprising:
providing a first group of data ports of one or more first elements of an integrated circuit;
providing a second group of data ports of one or more second elements of the integrated circuit;
providing a point-to-point connection between a first data port of the first group of data ports to a second data port of the second group of data ports; and
providing for the first data port, a distinct crossbar connected to every data port of the second group of data ports.

13. The method of claim 12, wherein the point-to-point connection is one of a plurality of point-to-point connections between each of the first group of data ports and each of the second group of data ports and wherein the distinct crossbar further includes for each of the first group of data ports a connection to every data port of the second group of data ports.

14. The method of claim 13, wherein the providing the point-to-point connections further includes:
configuring the point-to-point connections to carry a valid signal from each of the first group of data ports to each of the second group of data ports, the valid signal from a first data port of the first group of data ports being coincident at the second data port of the second group of data ports with data from the first data port for the second data port carried in the distinct crossbar for the first data port.

15. The method of claim 12, wherein the providing the point-to-point connections further includes:
configuring point-to-point connections to carry a credit release signal between each of the first group of data ports and each of the second group of data ports, the credit release signal for a first data port of the first group of data ports being provided from a second data port of the second group of data ports in response to data from the first data port being pulled from the second data port.

16. The method of claim 15, wherein the credit release signal corresponds to a credit, the credit being based on a round trip time added to an overhead for the first data port and the second data port.

17. The method of claim 12, further comprising:
providing, for each of the second group of data ports, an additional distinct crossbar connected to every data port of the first group of data ports.

18. The method of claim 12, wherein the providing the distinct crossbar further includes:
providing a plurality of pipeline stages to the second group of data ports.

19. The method of claim 12, wherein the first elements include a plurality of processing engines.

20. The method of claim 12, wherein the second elements include a plurality of caches.
